(19) United States
(12) Patent Application Publication
(10) Pub. No.: US 2013/0315123 A1
(43) Pub. Date: Nov. 28, 2013

(54) Method and Apparatus for Cellular Signaling

(71) Applicants: Henri KOSKINEN, Espoo (FI); Jarkko Koskela, Oulu (FI); Woonhee Hwang, Espoo (FI)

(72) Inventors: Henri KOSKINEN, Espoo (FI); Jarkko Koskela, Oulu (FI); Woonhee Hwang, Espoo (FI)

(73) Assignee: Nokia Corporation and Nokia Siemens Networks Oy

(21) Appl. No.: 13/477,203

(22) Filed: May 22, 2012

(51) Int. Cl. H04W 4/00; H04H 20/71

(52) U.S. Cl. 370/312; 455/422.1

(57) ABSTRACT

In accordance with an example embodiment of the present invention, there is provided an apparatus, including a memory configured to store a plurality of service provision group identifiers, at least one processing core configured to compile system information concerning a cell, the system information including a list including the service provision group identifiers, and at least one transmitter configured to cause the system information to be transmitted. In some embodiments, the list of service provision group identifiers is indicated in the system information as a list of service provision group identifiers which the cell represents, and the cell does not to a full extent represent at least one of the indicated service provision group identifiers.

### TECHNICAL FIELD

The present application relates generally to managing cellular network signaling.

### BACKGROUND

A cellular communications network typically comprises a plurality of individual cells. A cell is typically controlled by a base station, which may be connected to a backbone network by a wire-line connection. The backbone network may connect base stations to base station controllers or core network nodes. Base stations communicate with mobile stations within cell coverage areas of their cells using a wireless radio interface. A base station may control more than one cell.

The wireless radio interface may use radio resources, such as a spectrum band, allocated for use in cellular communication. To achieve interoperability between mobile stations built by a first manufacturer and base stations built by a second manufacturer, publicly available industry standards may define the functioning and signaling protocols of the cellular air interface. Mobile stations may be powered by rechargable batteries, whereas base stations and other network nodes may be powered via mains, with possible backup batteries arranged to provide some residual communications capability in case mains power becomes unavailable.

Cellular networks may offer various services to their subscribers in addition to voice calls between mobiles, and voice calls from mobiles to a fixed telephony network. For example, a network may provide for web browsing service to mobile stations capable of receiving data streams and presenting web pages to users on their displays. Networks may require users to register for access to services, which may be subject to a separate charge. Networks may be configured so that certain services are only available in certain cells, or groups of cells, in the network. Where this is the case, mobile stations may be pre-configured with lists of cells where services are available, or cells may advise mobile stations attached to them concerning services that may be provided in the cell.

Examples of digital services that cellular networks may provide include streaming video and audio, notifications, text messaging and cloud-based storage wherein mobile devices transmit data files into the network for storage. A further example is multimedia, such as unicast, multicast or broadcast multimedia, wherein at least one mobile registers to receive a copy of a multimedia resource, such as a stream, that may also be provided to other mobiles.

An example of a broadcasted multimedia service is a multimedia broadcast-multicast service, known as MBMS. MBMS is described in standards published by the 3^{rd} generation partnership project, 3GPP. MBMS is a unidirectional point-to-multipoint service in which data is transmitted from a single source entity to a group of users in a specific area. MBMS may be configured in two modes, broadcast and multicast. Other examples of multimedia broadcast services include MediaFLO and DVB-H/DVB-T.

### SUMMARY

Various aspects of examples of the invention are set out in the claims.

According to a first aspect of the present invention, there is provided an apparatus, comprising a memory configured to store a plurality of service provision group identifiers, at least one processing core configured to compile system information concerning a cell, the system information comprising a list comprising the service provision group identifiers, and at least one transmitter configured to cause the system information to be transmitted.

According to a second aspect of the present invention, there is provided an apparatus, comprising at least one processor, at least one memory including computer program code, the at least one memory and the computer program code configured to, with the at least one processor, cause the apparatus to at least receive system information from at least one macro cell, and subsequent to the receiving, cause the apparatus to become operable to transmit a service interest indication to a base station controlling a closed subscriber group cell.

According to a third aspect of the present invention, there is provided a method, comprising storing a plurality of service provision group identifiers, compiling system information concerning a cell, the system information comprising a list comprising the service provision group identifiers, and causing the system information to be transmitted.

According to a fourth aspect of the present invention, there is provided a method, comprising receiving system information from at least one macro cell, and subsequent to the receiving, causing an apparatus to become operable to transmit a service interest indication to a base station controlling a closed subscriber group cell.

According to further aspects of the present invention, computer programs and computer program products are provided. The computer program products comprise computer programs configured to cause methods according to various aspects of the present invention to be performed, when run.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example system capable of supporting at least some embodiments of the invention;

FIG. 2 illustrates a block diagram of an apparatus in accordance with an example embodiment of the invention;

FIG. 3 illustrates an example apparatus capable of supporting at least some embodiments of the present invention;

FIG. 4 illustrates cells and service provision groups in a cellular network in accordance with certain example embodiments of the invention;

FIG. 5 is a first flowchart illustrating a process according to at least some example embodiments of the invention, and

FIG. 6 is a second flowchart illustrating a process according to at least some example embodiments of the invention.

### DETAILED DESCRIPTION OF THE DRAWINGS

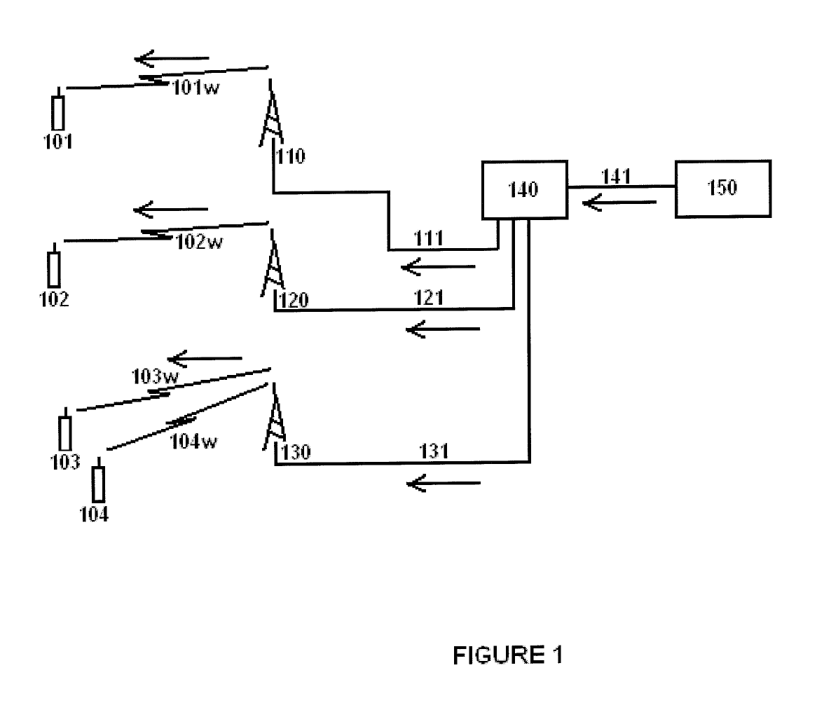

An example embodiment of the present invention and its potential advantages are understood by referring to FIGS. 1 through 6 of the drawings.

FIG. 1 illustrates an example system capable of supporting at least some embodiments of the invention. FIG. 1 illustrates an example cellular system, such as for example a long term evolution, LTE, or wideband code division multiple access, WCDMA, system. The illustrated system comprises a server node 150, which is connected via interface 141 to a core network node 140. Server node 150 may provide interfaces to further networks, which are not illustrated in FIG. 1. Server node 150 may comprise, for example, a broadcast/multicast service center, BM-SC. Core network node 140 may comprise, for example, a gateway, switch, mobility management entity, MME, or serving general packet radio service, GPRS, support node, SGSN. Core network node 140 may provide services to the network that relate to managing the network. Such services may comprise, for example, managing user mobility, managing subscriber information, providing authentication, and facilitating ciphering and/or billing.

Core network node 140 is linked to base stations 110, 120 and 130 via instances 111, 121 and 131, respectively, of a multicast interface. For example in an LTE system, this interface may be an M1 interface as defined by 3GPP. Base stations 110, 120 and 130 communicate with mobile stations over a wireless interface. Base station 110 is illustrated as communicating with mobile 101 via wireless interface 101w. Base station 120 is illustrated as communicating with mobile 102 via wireless interface 102w. Base station 130 is illustrated as communicating with mobile 103 via wireless interface 103w, and mobile 104 via wireless interface 104w. Wireless interfaces 101w, 102w, 103w and 104w may each have an uplink for conveying information from the mobile toward a base station, and a downlink for conveying information from the base station toward a mobile. The wireless links may operate in accordance with the standard the cellular system uses, for example where the system is a WCDMA system, the wireless links may be WCDMA wireless links. Where the system is a LTE system, the wireless links may be LTE wireless links.

In the illustrated example, mobile stations 101, 102 and 103 receive a multimedia service, which may be distributed from server 150, for example. As illustrated by arrows in FIG. 1, data relating to the multimedia service is transmitted from server 150 to core network node 140 via interface 141. Core network node 140 multicasts data for any base station in its area that belongs to the service provision group of the multimedia service. In the illustrated example, core network node 140 is configured to transmit the data to base stations 110, 120 and 130 via interfaces 111, 121 and 131, respectively. This is illustrated with arrows next to interfaces 111, 121 and 131. Base station 110 serves mobile 101. Base station 110 broadcasts a copy of the data, for reception by mobile 101. Base station 120 serves mobile 102. Base station 120 broadcasts a copy of the data, for reception by mobile 102. Base station 130 serves mobiles 103 and 104. However, for example in case of MBSFN operation, mobile 101 may receive transmission from other base stations in addition to base station 110 and combine the received signals. Base station 130 broadcasts a copy of the data, for reception by mobiles 103 and 104.

In the illustrated example, base stations of the service provision group join the multicast-distribution tree of the broadcast data in order to receive their own copy of the data. In some embodiments, a multimedia service may be broadcast in a certain area comprising at least one cell regardless of whether there is at least one mobile interested in receiving the service or not.

Multimedia services may be provided in specific service provision groups which comprise cells, wherein the service may be obtained when a mobile station is attached to a cell that is comprised in the service provision group of the service. Being attached to a cell may comprise having the cell as a primary point of reference in the cellular network, the network directing incoming communications addressed to the mobile station to the cell and the mobile transmitting signaling messages to the cell. Where service provision groups comprise individual cells, a single base station may control cells that are comprised in a certain service provision group and also at least one cell that is not comprised in the service provision group. A mobile may obtain knowledge of available services and their respective service provision groups, wherein service provision groups may be identified by one or more service provision group identifiers. A mobile that is interested in receiving a specific service may be configured to check, if a cell it is attached to is comprised in the service provision group. A mobile may discover whether the cell is comprised in the service provision group of the service by receiving a system information block from the cell, for example. Where the system information comprises a service provision group identifier of the service provision group, the mobile may be configured to consider the cell as comprised in the service provision group, in other words representing the service provision group identifier. As another example, a mobile may form a data connection to a server apparatus disposed in the cellular network and transmit a request comprising an identifier of the cell. The server may respond by transmitting a response message comprising an indication as to whether the cell is comprised in the service provision group of the service. An address or domain name of the server may be pre-configured in the mobile by an operator of the cellular network. The address or domain name may be stored on a removable subscriber identity module provided to a subscriber by the operator, for example.

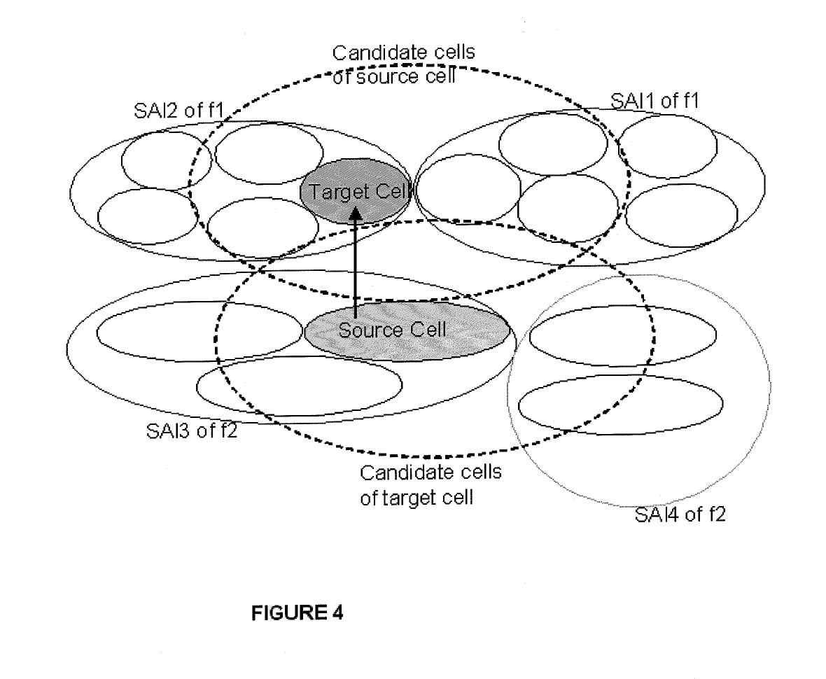

FIG. 4 illustrates cells and service provision groups in a cellular network in accordance with certain example embodiments of the invention. Illustrated in FIG. 4 is a source cell, a target cell and candidate cells of the source cell and target cell, respectively. Candidate cells refer to cells that are handover candidates from a given cell, for example candidate cells of the source cell are cells into which a mobile may be handed over from the source cell as it roams in the network. For handover a mobile may measure beacon signals transmitted from a cell it is currently attached to, as well as other cells in the vicinity. The mobile may be configured to transmit measurement reports concerning signal strengths received from the cells to the network, responsive to which the network may decide that due to movement of the mobile, it is more appropriate to offer service to the mobile from another cell than the cell the mobile is currently attached to. A change in cell a mobile is attached to is known as a handover. Alternatively to transmitting measurement reports, in some systems the mobile may decide on handovers independently and inform the network of handover decisions it has taken.

In FIG. 4 are also illustrated service provision groups, or service areas, SA1, SA2, SA3 and SA4, which are illustrated in terms of their respective identifiers, for example SAI1 is the identifier of SA1. SAI1 and SAI2 comprise cells operating on frequency f1. SAI3 and SAI4 comprise cells operating on frequency f2. In the illustrated example, a mobile attached to the source cell that is interested in services offered in service provision groups represented by identifiers SAI1 and SAI4. When the mobile is attached to the source cell, it is capable of receiving neither of these two services because it isn't operating at the right location or on the right frequency. The source cell may be configured to indicate as available also service provision group identities of service groups available in candidate cells at a different frequency than the source cell. In this case, the source cell would indicate to the mobile that SAI3 is represented by the source cell, and also SAI2 and SAI1 are available on f1 since these service groups are available on frequency f1, and at least one candidate cell of the source cell exists in both SAI1 and SAI2 on f1. Responsively, since the mobile is interested in receiving the service of SAI1, the mobile may indicate to the source cell that it is interested in service on f1, and the network may responsively cause a handover to the target cell. In the illustrated example, however, the target cell on frequency f1 isn't comprised in service provision area SAI1.

In the target cell, the mobile can't access SAI1 or SAI4. The target cell will indicate to the mobile that SAI2 is represented by the target cell, and also SAI3 and SAI4 are available on frequency f2. The mobile interested in SAI1 and SAI4 would then indicate that it is interested in service on f2, and the network may cause a handover to one of the candidate cells of the target cell on frequency f2. In other words, unnecessary inter-frequency handovers may occur that don't increase the access of the mobile to either service it is interested in receiving.

One way to prevent the aforementioned unnecessary handovers would be for the source cell to indicate it represents all service provision group identifiers that are actually represented by cells adjacent to the source cell on the same frequency, in addition to any service provision groups the source cell actually represents. In the illustrated example, cells comprised in SAI4 are adjacent to the source cell on the same frequency, f2, so the source cell could be modified to indicate to the mobile that it represents both SAI3 and SAI4. Since the mobile was interested in SAI4 and it's indicated as available, the process leading to unnecessary handovers may be avoided.

The mobile may attempt to obtain the service of SAI4 via the source cell to which it is attached responsive to being informed, by the source cell, that the source cell represents SAI4. Since the source cell is actually not comprised in SA4 the service will not be obtainable and the mobile may be informed of an error condition. In some embodiments, service is not always obtainable even via a cell that is comprised in the respective service provision area, possible reasons including too few mobiles attached to the cell requesting the service, that radio resources were reserved for higher-priority traffic or a service that has not yet started.

A special case of a cell is a closed subscriber group, CSG, cell, which is defined as a cell that only a subset of subscribers can attach to. In other words, the CSG cell is comprised in a broader network with a first plurality of subscribers, and only a second plurality of subscribers is eligible to attach to the CSG cell, wherein the second plurality is a subset of the first plurality. A CSG cell may be used to provide a subset of users, for example premium service level users, services that may be unavailable in the broader network. A CSG cell may provide access to taxi centres, email servers, intranets, extranets, or simply provide localized additional capacity for voice traffic in a cellular network. Mobiles eligible to attach to CSG cells may be provided with lists of CSG cell identifiers they have access to. In addition to the CSG cell being able to provide services not available in the broader network, some services of the broader network may be unavailable in the CSG cell. For example, multimedia services such as, for example, at least one of multimedia broadcast, multicast and messaging, may be unavailable in some or all CSG cells.

A mobile attached to a CSG cell may be interested in receiving multimedia services not offered by the CSG cell. In some embodiments, the mobile may listen for system information broadcasts from neighbouring or nearby non-CSG cells in the broader network and determine which multimedia services they offer. A CSG cell not offering multimedia services may be configured to not indicate any multimedia services as being available, for example indicate this in broadcasted system information. Responsive to determining that a nearby non-CSG cell, which may be a neighbour cell of the CSG cell or another nearby cell, offers a multimedia service a mobile is interested in receiving, the mobile may express an interest in multimedia service to the CSG cell. The expression of interest may be signaled from the mobile to the CSG cell in a signaling message, which may comprise an identifier of the frequency the CSG cell operates on, for example. The frequency may be the same as that of the cell offering the desired service. In some embodiments, the signaling message comprises alternatively or in addition an identifier of the desired service, which may be expressed as a service provision group identifier, for example. Non-CSG cells may be referred to as macro cells.

In general, there is provided an apparatus, such as for example a base station or a control device for inclusion in a base station, to control the functioning of the base station. The apparatus may comprise a memory configured to store a plurality of service provision group identifiers. The memory may be comprised in an internal memory in a control device for controlling a base station, for example. Alternatively, the memory may be comprised in a base station apparatus externally to the control device. The apparatus may further comprise at least one processing core configured to compile system information concerning a cell, the system information comprising a list comprising the service provision group identifiers. The apparatus may further comprise a transmitter configured to cause the system information to be transmitted. The cell may be a cell controlled by the apparatus, for example where the apparatus is a base station, the cell may be a cell controlled by the base station. Where the apparatus is a base station, the transmitter may be a radio transmitter comprised in the base station. Where the apparatus is a control device, the transmitter may comprise an output device of the control device, such as for example a serial port and pin of a processor, wherein the processor may be configured to cause transmission by controlling the operation of a radio transmitter of a base station by signaling to the radio transmitter internally in the base station using the serial port and pin.

In some embodiments, the service provision group identifiers comprise multimedia broadcast-multicast service service-area identities. In some embodiments, the service provision group identifiers comprise server group identities. In some embodiments, transmitting the system information comprises broadcasting the system information. Broadcasting may refer to transmitting in a cell without directing or addressing the transmission to any device in particular. Broadcasting may take place on a dedicated broadcast channel specific to a cell.

In some embodiments, the system information comprises exactly one list of service provision group identifiers, in other words the service provision group identifiers are not grouped into two or more separate lists in the system information. In some embodiments, the system information comprises exactly one list per frequency. In other words, the system information in these embodiments comprises a plurality of service provision group identifiers for each frequency the system information comprises service provision group identifiers for. In some embodiments, the list or lists do not separate the service provision group identifiers into ones the cell represents and ones the cell does not represent.

In some embodiments, the list or lists of service provision group identifiers are indicated either implicitly or explicitly as a list or lists of service provision group identifiers represented by the cell, although the cell does not to the full extent represent at least one of the indicated service provision group identifiers. Being indicated as a list of service provision group identifiers which the cell represents may comprise that the list is comprised in a data structure comprised in the system information, wherein the data structure is defined in industry standards as containing a list of service provision group identifiers which the cell represents. Alternatively, the transmitted system information may comprise a label describing the data structure as containing a list of service provision group identifiers which the cell represents. Representing a service group identifier to a full extent may comprise at least one, and in some embodiments all, of 1) a cell transmitting to mobiles over an air interface the service provision group identifier indicated as a service provision group identifier that the cell represents, 2) the cell indicating toward a core network node or radio-access network control node that the cell represents the service provision group identifier, and 3) responsive to receiving a start command, the cell is configured to begin broadcasting the service. For example, a cell performing 1) but not 2) may indicate it represents a service provision group identifier, without representing it to the full extent.

In some embodiments, each of the plurality of service provision group identifiers indicated by a cell are ones which either the cell represents to the full extent, or a cell neighbouring the cell represents to the full extent, wherein the neighbouring cell operates on a same frequency as the cell.

In general, there is provided a second apparatus, such as for example a mobile station, comprising at least one processor, at least one memory including computer code, wherein the memory and the computer program code configured to, with the at least one processor, cause the second apparatus to receive system information from at least one macro cell. A macro cell may be a non-closed subscriber group cell comprised in a broader cellular network, wherein the macro cell may be accessible to all subscribers of the cellular network. Subsequent to receiving the system information, the second apparatus may be configured to become operable to transmit to a base station controlling a closed subscriber group cell a service interest indication. For example, where the second apparatus is a mobile, it may first receive the system information from the at least one macro cell while attached to a macro cell, then roam to a closed subscriber group cell, and transmit the service interest indication to the closed subscriber group cell. Alternatively, the second apparatus may be attached to the closed subscriber group cell while receiving the system information from the at least one macro cell.

In some embodiments, system information received from the closed subscriber group cell comprises no service provision group identifiers. As described above, at least some closed subscriber group cells offer a different set of services than macro cells, wherein closed subscriber group cells may lack ability to offer certain multimedia services. In some embodiments, the service provision group identifiers comprise multimedia broadcast-multicast service service-area identities.

In some embodiments, the second apparatus is configured to receive the system information from the at least one macro cell by listening to system information the at least one macro cell broadcasts. In some embodiments, the service interest indication comprises at least one multimedia broadcast-multicast service interest indication comprising an indication of a frequency in use in communication between the apparatus and the closed subscriber group cell.

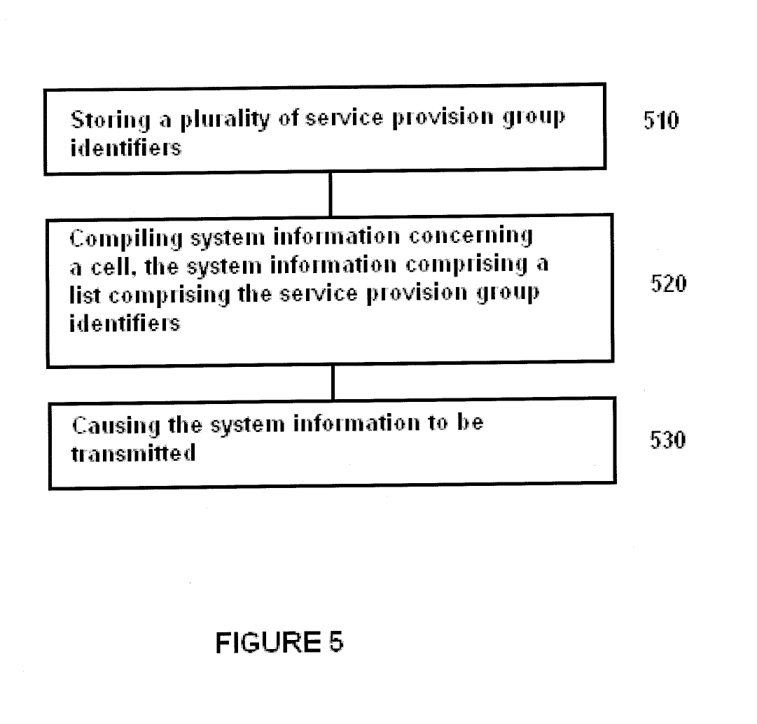

FIG. 5 is a first flowchart illustrating a process according to at least some example embodiments of the invention. The phases of the illustrated method may take place in a base station controlling a cell, for example. In phase 510, a plurality of service provision group identifiers is stored. In phase 520, system information concerning a cell is compiled, the system information comprising at least a list of the service provision group identifiers. The service provision group identifiers may alternatively be comprised in the system information also in other formats than a list. In phase 530, the system information, comprising the service provision group identifiers, is caused to be transmitted.

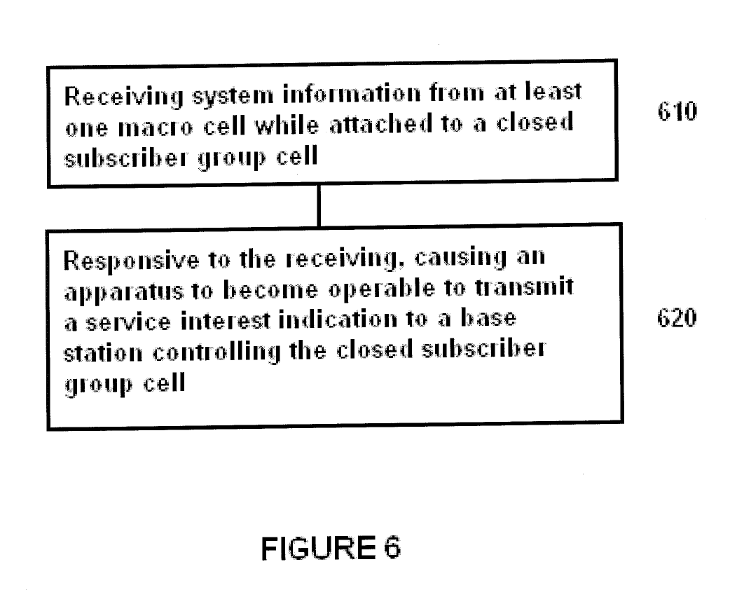

FIG. 6 is a second flowchart illustrating a process according to at least some example embodiments of the invention. The phases of the illustrated method may take place in a mobile station such as, for example, a user equipment operating in accordance with the WCDMA or LTE standards. In phase 610, system information is received from at least one macro cell while attached to a closed subscriber group cell. A macro cell may comprise a non-closed subscriber group cell in the sense that a cellular network comprises closed subscriber group cells and non-closed subscriber group cells. The receiving of phase 610 may comprise that an apparatus performing the method of FIG. 6, such as for example a user equipment, is attached solely to a closed subscriber group cell and not a macro cell while the receiving takes place.

In phase 620, responsive to the receiving, the apparatus is caused to become operable to transmit a service interest indication to the closed subscriber group cell. Transmitting to the cell may comprise transmitting to a base station controlling the cell. Becoming operable may comprise that responsive to the receiving, the apparatus either transmits the interest indication without waiting for further inputs, or that responsive to the receiving, the apparatus will transmit the interest indication once at least one further triggering event occurs. Examples of such a further triggering event include a user request for a service and a specific timer expiring.

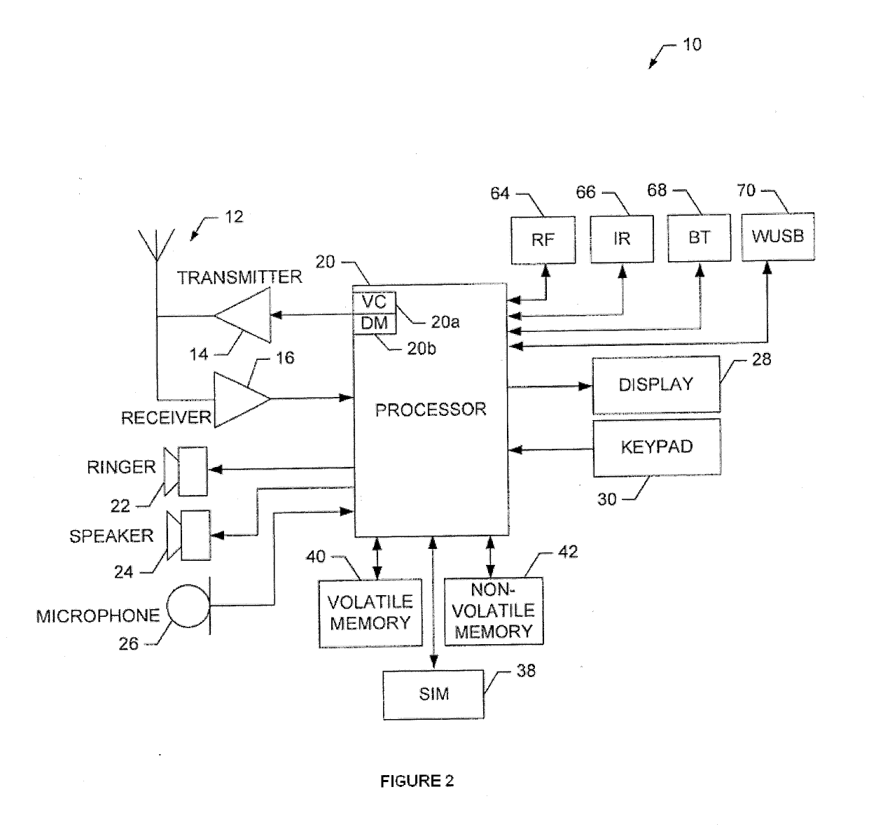

FIG. 2 illustrates a block diagram of an apparatus 10 such as, for example, a mobile terminal, in accordance with an example embodiment of the invention. While several features of the apparatus are illustrated and will be hereinafter described for purposes of example, other types of electronic devices, such as mobile telephones, mobile computers, portable digital assistants, PDAs, pagers, laptop computers, desktop computers, gaming devices, televisions, routers, home gateways, and other types of electronic systems, may employ various embodiments of the invention.

As shown, the mobile terminal 10 may include at least one antenna 12 in communication with a transmitter 14 and a receiver 16. Alternatively transmit and receive antennas may be separate. The mobile terminal 10 may also include a processor 20 configured to provide signals to and receive signals from the transmitter and receiver, respectively, and to control the functioning of the apparatus. Processor 10 may be configured to control the functioning of the transmitter and receiver by effecting control signaling via electrical leads to the transmitter and receiver. Likewise processor 10 may be configured to control other elements of apparatus 10 by effecting control signaling via electrical leads connecting processor 20 to the other elements, such as for example a display or a memory. The processor 20 may, for example, be embodied as various means including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an application specific integrated circuit, ASIC, or field programmable gate array, FPGA, or some combination thereof. Accordingly, although illustrated in FIG. 2 as a single processor, in some embodiments the processor 20 comprises a plurality of processors or processing cores. Signals sent and received by the processor 20 may include signaling information in accordance with an air interface standard of an applicable cellular system, and/or any number of different wireline or wireless networking techniques, comprising but not limited to Wi-Fi, wireless local access network, WLAN, techniques such as Institute of Electrical and Electronics Engineers, IEEE, 802.11, 802.16, and/or the like. In addition, these signals may include speech data, user generated data, user requested data, and/or the like. In this regard, the apparatus may be capable of operating with one or more air interface standards, communication protocols, modulation types, access types, and/or the like. More particularly, the apparatus may be capable of operating in accordance with various first generation, 1G, second generation, 2G, 2.5G, third-generation, 3G, communication protocols, fourth-generation, 4G, communication protocols, Internet Protocol Multimedia Subsystem, IMS, communication protocols, for example, session initiation protocol, SIP, and/or the like. For example, the apparatus may be capable of operating in accordance with 2G wireless communication protocols IS-136, Time Division Multiple Access TDMA, Global System for Mobile communications, GSM, IS-95, Code Division Multiple Access, CDMA, and/or the like. Also, for example, the mobile terminal may be capable of operating in accordance with 2.5G wireless communication protocols General Packet Radio Service. GPRS, Enhanced Data GSM Environment, EDGE, and/or the like. Further, for example, the apparatus may be capable of operating in accordance with 3G wireless communication protocols such as Universal Mobile Telecommunications System, UMTS, Code Division Multiple Access 2000, CDMA2000, Wideband Code Division Multiple Access, WCDMA, Time Division-Synchronous Code Division Multiple Access, TD-SCDMA, and/or the like. The apparatus may be additionally capable of operating in accordance with 3.9G wireless communication protocols such as Long Term Evolution, LTE, or Evolved Universal Terrestrial Radio Access Network, E-UTRAN, and/or the like. Additionally, for example, the apparatus may be capable of operating in accordance with fourth-generation, 4G, wireless communication protocols such as LTE Advanced and/or the like as well as similar wireless communication protocols that may be developed in the future.

Some Narrow-band Advanced Mobile Phone System, NAMPS, as well as Total Access Communication System, TACS, mobile terminal apparatuses may also benefit from embodiments of this invention, as should dual or higher mode phone apparatuses, for example, digital/analog or TDMA/CDMA/analog phones. Additionally, apparatus 10 may be capable of operating according to Wi-Fi or Worldwide Interoperability for Microwave Access, WiMAX, protocols.

It is understood that the processor 20 may comprise circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder, VC, 20a, an internal data modem, DM, 20b, and/or the like. Further, the processor may comprise functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the mobile terminal 10 to transmit and receive web content, such as location-based content, according to a protocol, such as wireless application protocol, WAP, hypertext transfer protocol, HTTP, and/or the like

Apparatus 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. Although not shown, the apparatus may comprise a battery for powering various circuits related to the mobile terminal, for example, a circuit to provide mechanical vibration as a detectable output. The user input interface may comprise devices allowing the apparatus to receive data, such as a keypad 30, a touch display, which is not shown, a joystick, which is not shown, and/or at least one other input device. In embodiments including a keypad, the keypad may comprise numeric 0-9 and related keys, and/or other keys for operating the apparatus.

As shown in FIG. 2, apparatus 10 may also include one or more means for sharing and/or obtaining data. For example, the apparatus may comprise a short-range radio frequency, RF, transceiver and/or interrogator 64 so data may be shared with and/or obtained from electronic devices in accordance with RF techniques. The apparatus may comprise other short-range transceivers, such as, for example, an infrared, IR, transceiver 66, a Bluetooth™, BT, transceiver 68 operating using Bluetooth™ brand wireless technology developed by the Bluetooth™ Special Interest Group, a wireless universal serial bus, USB, transceiver 70 and/or the like. The Bluetooth™ transceiver 68 may be capable of operating according to low power or ultra-low power Bluetooth™ technology, for example, Wibree™, radio standards. In this regard, the apparatus 10 and, in particular, the short-range transceiver may be capable of transmitting data to and/or receiving data from electronic devices within a proximity of the apparatus, such as within 10 meters, for example. Although not shown, the apparatus may be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise memory, such as a subscriber identity module, SIM, 38, a removable user identity module, R-UIM, and/or the like, which may store information elements related to a mobile subscriber. In addition to the SIM, the apparatus may comprise other removable and/or fixed memory. The apparatus 10 may include volatile memory 40 and/or non-volatile memory 42. For example, volatile memory 40 may include Random Access Memory, RAM, including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, etc., optical disc drives and/or media, non-volatile random access memory, NVRAM, and/or the like. Like volatile memory 40 non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing functions of the mobile terminal. For example, the memories may comprise an identifier, such as an international mobile equipment identification, IMEI, code, capable of uniquely identifying apparatus 10.

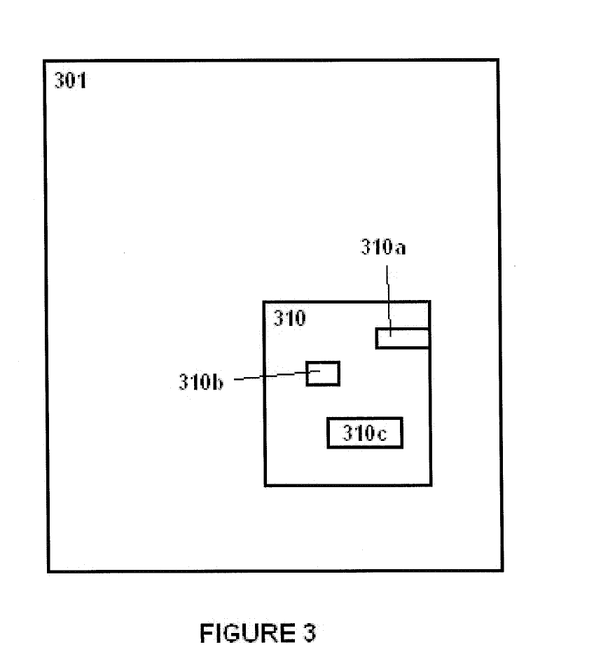

FIG. 3 illustrates an example apparatus 301 capable of supporting at least some embodiments of the present invention. The apparatus may correspond to base station 110 of FIG. 1, for example. The apparatus is a physically tangible object, for example a standalone network node or a network node combined with another node into a single standalone unit. The apparatus may comprise a control apparatus 310, for example at least one digital signal processor, DSP, processor, field-programmable gate array, FPGA, application-specific integrated circuit, ASIC, chipset or controller. The apparatus may further comprise a transmitter and/or a receiver 310a configured to enable the apparatus 301 to connect to other apparatuses. A combination of transmitter and receiver may be called a transceiver. The apparatus may comprise memory 310b configured to store information, for example information on multimedia service availability. The memory may be solid-state memory, dynamic random access memory, DRAM, magnetic, holographic or other kind of memory. The apparatus may comprise logic circuitry 310c configured to access the memory 310b and control the transmitter and/or a receiver 310a. The logic circuitry 310c may be implemented as software, hardware or a combination of software and hardware. The logic circuitry may comprise at least one processing core. The logic circuitry 310c may execute program code stored in memory 310b to control the functioning of the apparatus 301 and cause it to perform functions related to embodiments of the invention. The logic circuitry 310c may be configured to initiate functions in apparatus 301, for example the sending of data units via the transmitter and/or a receiver 310a. The logic circuitry 310c may be control circuitry. The transmitter and/or a receiver 310a, memory 310b and/or logic circuitry 310c may comprise hardware and/or software elements comprised in the control apparatus 310. Memory 310b may be comprised in the control apparatus 310, be external to it or be both external and internal to the control apparatus 310 such that the memory is split to an external part and an internal part. If the apparatus 301 does not comprise a control apparatus 310 the transmitter and/or a receiver 310a, memory 310b and logic circuitry 310c may be comprised in the apparatus as hardware elements such as integrated circuits or other electronic components. The same applies if the apparatus 301 does comprise a control apparatus 310 but some, or all, of the transmitter and/or a receiver 310a, memory 310b and logic circuitry 310c are not comprised in the control apparatus 310.

Without in any way limiting the scope, interpretation, or application of the claims appearing below, a technical effect of one or more of the example embodiments disclosed herein is that unnecessary handovers are avoided. Another technical effect of one or more of the example embodiments disclosed herein is that by avoiding unnecessary handovers, unnecessary handover-related signaling is avoided. Another technical effect of one or more of the example embodiments disclosed herein is that by avoiding unnecessary signaling, interference and mobile device battery consumption are reduced. Another technical effect of one or more of the example embodiments disclosed herein is that when necessary for reception of certain service, handover of a user equipment may be carried out.

Embodiments of the present invention may be implemented in software, hardware, application logic or a combination of software, hardware and application logic. The software, application logic and/or hardware may reside on memory 310b, the control apparatus 310 or electronic components, for example. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 2. A computer-readable medium may comprise a computer-readable non-transitory storage medium that may be any media or means that can contain or store the instructions for use by or in connection with an instruction execution system, apparatus, or device, such as a computer. The scope of the invention comprises computer programs configured to cause methods according to embodiments of the invention to be performed.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus, comprising:
a memory configured to store a plurality of service provision group identifiers;
at least one processing core configured to compile system information concerning a cell, the system information comprising a list comprising the service provision group identifiers; and
at least one transmitter configured to cause the system information to be transmitted.

2. An apparatus according to claim 1, wherein each of the plurality of service provision group identifiers comprises a multimedia broadcast-multicast service service-area identity.

3. An apparatus according to claim 1, wherein each of the plurality of service provision group identifiers comprises a server group identity.

4. An apparatus according to claim 1, wherein the transmitter is configured to cause the system information to be transmitted by causing the system information to be broadcasted.

5. An apparatus according to claim 1, wherein the system information comprises no more than one list of service provision group identifiers.

6. An apparatus according to claim 1, wherein the list of service provision group identifiers is implicitly or explicitly indicated in the system information as a list of service provision group identifiers which the cell represents, and the cell does not to a full extent represent at least one of the indicated service provision group identifiers.

7. An apparatus according to claim 6, wherein the apparatus comprises a cellular base station controlling the cell, and each indicated service provision group identifier is a service provision group identifier which either the cell or a neighbouring cell operating on a same carrier frequency represents to the full extent.

8. An apparatus, comprising:
at least one processor; and
at least one memory including computer program code the at least one memory and the computer program code configured to, with the at least one processor, cause the apparatus to perform at least the following:
receive system information from at least one macro cell, and
subsequent to the receiving, cause the apparatus to become operable to transmit a service interest indication to a base station controlling a closed subscriber group cell.

9. An apparatus according to claim 8, wherein system information received in the apparatus from the closed subscriber group cell comprises no service provision group identifiers.

10. An apparatus according to claim 9, wherein the service provision group identifiers comprise multimedia broadcast-multicast service service-area identities.

11. An apparatus according to claim 8, wherein the receiving comprises receiving via a wireless broadcast transmission.

12. An apparatus according to claim 8, wherein the service interest indication comprises a multimedia broadcast-multicast service interest indication comprising an indication of a frequency in use in communication between the apparatus and the closed subscriber group cell.

13. A method, comprising:
storing a plurality of service provision group identifiers;
compiling system information concerning a cell, the system information comprising a list comprising the service provision group identifiers, and
causing the system information to be transmitted.

14. A method according to claim 13, wherein each of the plurality of service provision group identifiers comprises a multimedia broadcast-multicast service service-area identity.

15. A method according to claim 13, wherein each of the plurality of service provision group identifiers comprises a server group identity.

16. A method according to claim 13, wherein causing the system information to be transmitted comprises causing the system information to be broadcasted.

17. A method according to claim 13, wherein the system information comprises no more than one list of service provision group identifiers.

18. A method according to claim 13, wherein the list of service provision group identifiers is implicitly or explicitly indicated in the system information as a list of service provision group identifiers which the cell represents, and the cell does not to a full extent represent at least one of the indicated service provision group identifiers.

19. A method according to claim 18, wherein each indicated service provision group identifier is a service provision group identifier which either the cell or a neighbouring cell operating on a same carrier frequency represents to the full extent.

20. A method, comprising;
receiving system information from at least one macro cell, and
subsequent to the receiving, causing an apparatus to become operable to transmit a service interest indication to a base station controlling a closed subscriber group cell.

21. A method according to claim 20, wherein system information received in the apparatus from the closed subscriber group cell comprises no service provision group identifiers.

22. A method according to claim 20, wherein the service provision group identifiers comprise multimedia broadcast-multicast service service-area identities.

23. A method according to claim 20, wherein the receiving comprises receiving via a wireless broadcast transmission.

24. A method according to claim 20, wherein the service interest indication comprises a multimedia broadcast-multicase service interest indication comprising an indication of a frequency in use in communication between the apparatus and the closed subscriber group cell.

25. A computer program product comprising a computer-readable medium bearing computer program code embodied therein for use with a computer, the computer program code comprising:
code for storing a plurality of service provision group identifiers;
code for compiling system information concerning a cell, the system information comprising a list comprising the service provision group identifiers, and
code for causing the system information to be transmitted.

26. A computer program product comprising a computer-readable medium bearing computer program code embodied therein for use with a computer, the computer program code comprising:
code for receiving system information from at least one macro cell, and
code for, subsequent to the receiving, causing an apparatus to become operable to transmit a service interest indication to a base station controlling a closed subscriber group cell.
